(19) United States
(12) Patent Application Publication
(10) Pub. No.: US 2024/0005702 A1
(43) Pub. Date: Jan. 4, 2024

(54) BIOMETRIC OPTICAL ANTISPOOFING BASED ON IMAGING THROUGH SPATIALLY VARYING OPTICAL FILTER

(71) Applicant: Fingerprint Cards Anacatum IP AB, Göteborg (SE)

(72) Inventors: Arvid HAMMAR, GÖTEBORG (SE); Hans MARTINSSON, GÖTEBORG (SE); Su LIU, ALINGSÅS (SE)

(73) Assignee: Fingerprint Cards Anacatum IP AB, Göteborg (SE)

(21) Appl. No.: 18/039,337

(22) PCT Filed: Nov. 29, 2021
(86) PCT No.: PCT/SE2021/051182

§ 371 Date: May 30, 2023

(30) Foreign Application Priority Data
Dec. 1, 2020 (SE) 2051398-2

(51) Int. Cl. G06V 40/40; G06V 40/13; G06V 10/143

(52) U.S. Cl. CPC G06V 40/40; G06V 40/1318; G06V 10/143

(57) ABSTRACT

A biometric imaging arrangement comprises an image sensor comprising a photodetector pixel array for capturing an image of an object. An infrared cut-off filter is arranged to at least partly cover the photodetector pixel array. The infrared cut-off filter comprises a first filter area having a first transmission wavelength band including wavelengths in the visible range of wavelengths, and at least two additional filter areas having transmission wavelength bands including wavelengths in the visible range of wavelengths. The transmission wavelength bands of the additional filter areas being different from the first transmission wavelength band, wherein at least two of the additional filter areas are spatially separated by the first filter area.

### TECHNICAL FIELD

The present invention generally relates to a biometric imaging arrangement, to an electronic device comprising a biometric imaging arrangement, to a method for biometric authentication, and to a method for manufacturing an infrared cut-off filter.

### BACKGROUND

Biometric systems are widely used as means for increasing the convenience and security of personal electronic devices, such as mobile phones etc. Fingerprint sensing systems are now included in a large proportion of all newly released consumer electronic devices, such as mobile phones.

Optical fingerprint sensors have been known for some time and may be a feasible alternative to e.g. capacitive fingerprint sensors in certain applications. Optical fingerprint sensors may for example be based on the pinhole imaging principle and/or may employ micro-channels, i.e. collimators or microlenses to focus incoming light onto an image sensor.

One of the problems associated with fingerprint sensors concerns so-called spoof fingers trying to mimic a live fingerprint to thereby deceive a fingerprint sensor. If fraud by the spoof finger is successful, unauthorized access to systems may undesirably be approved or unauthorized transactions may be approved which may lead to disastrous consequences. A common approach to assess the liveness of an object using optical fingerprint sensors is to filter the light transmitted from an object and study for example the amount of red light detected by the sensor. For this, pixels of the optical sensor are covered by red filters, which are in addition to e.g. infrared filters thereby leading to integration and manufacturing challenges.

It is therefore of interest to provide improved optical components that provides for preventing unauthorized access using biometric spoofs.

### SUMMARY

In view of above-mentioned and other drawbacks of the prior art, it is an object of the present invention to provide a biometric imaging arrangement with an improved filter that provides for spoof detection capabilities and that is more easily integrated in a biometric imaging solution.

According to a first aspect of the invention, there is provided a biometric imaging arrangement comprising: an image sensor comprising a photodetector pixel array for capturing an image of an object, and an infrared cut-off filter arranged to at least partly cover the photodetector pixel array.

The infrared cut-off filter comprises a first filter area having a first transmission wavelength band including wavelengths in the visible range of wavelengths, and at least two additional filter areas having transmission wavelength bands including wavelengths in the visible range of wavelengths.

The transmission wavelength bands of the additional filter areas being different from the first transmission wavelength band, wherein at least two of the additional filter areas are spatially separated by the first filter area.

The present invention is based on the realization to provide an infrared cut-off filter with spatially varying filtering properties in the visible range of wavelengths. This provides for a single filter component to enable both infrared cut-off filtering required for most image sensors, and filtering properties that advantageously provide for anti-spoofing. More precisely, two spatially separated filter areas that has different transmission wavelength bands compared to the transmission wavelength band of the intermediate first filter area, may be used for anti-spoofing.

For example, the additional filter areas, which may be utilized for anti-spoofing can be arranged in parts of the photodetector pixel array that are not normally required for high-quality imaging. Anti-spoofing does not necessarily need high-quality images but may instead rely on analyzing spectral content of the detected light, whereby pixels related to low-quality parts of the image may be employed. This was realized by the inventors who thereby designed an infrared cut-off filter to have spatially varying filtering properties also in the visible range of wavelengths used for anti-spoofing. The inventive infrared cut-off filter may replace the traditionally used infrared cut off filter.

That the transmission wavelength bands are different allows them to at least partly overlap. Thus, that the transmission wavelength bands are different means that at least one of the cut-off wavelengths of one of the transmission wavelength bands is different from the cut-off wavelengths of the other one of the transmission wavelengths bands.

The filter areas may be arranged in the same general plane, preferably parallel with the plane of the photodetector pixel array. That the at least two of the additional filter areas are spatially separated by the first filter area means that the at least two of the additional filter areas are two distinct areas that are not directly adjacent to each other, i.e. they do not share a common border or boundary between them. The first filter area separates the at least two of the additional filter areas such that the at least two of the additional filter areas may form individual islands.

However, the material of the filtering areas is not required to be arranged in the same layer or plane. For example, a first filter material providing filtering according to the first filtering area may at least partly overlap with a second material providing filtering according to the additional filtering areas. Thus, the additional filtering areas are spatially separated by the first area, but the layer of material providing the filter(s) in the additional areas may be a continuous layer that reaches beyond or outside of the first filter area.

The term “image sensor” should be interpreted broadly and may be any suitable type of image sensor, such as a CMOS or CCD sensor connected to associated control and readout circuitry. In one possible implementation the image sensor is a thin-film transistor (TFT) based image sensor which provides a cost-efficient solution. The photodetectors are individually controllable and configured to detect an amount of incoming light and to generate an electric signal indicative of the light received by the detector. The operation and control of such image sensors can be assumed to be known and will not be discussed herein.

Infrared cut-off generally means that light of wavelengths in the infrared range, i.e. above approximately 600 nm, or approximately 580 nm, or approximately 650 nm, or approximately 700 nm are attenuated. Wavelengths at or above approximately 900 nm are significantly suppressed or even blocked by the infrared cut-off filter.

The visible wavelength range is herein from approximately 380 nm to approximately 740 nm.

Red light may herein be considered light of wavelengths in the range from approximately 600 nm to approximately 740 nm.

Blue light may herein be considered light of wavelengths in the range from approximately 450 nm to approximately 500 nm.

Green light may herein be considered light of wavelengths in the range from approximately 500 nm to approximately 565 nm.

Different types of filters or combinations of filters may be conceivable. For example, interference filters are generally based on reflecting some wavelengths and transmitting other wavelengths with little or no absorption. Interference filters may comprise a layered structure of dielectrics that yield angular-dependent transmission spectrums. Absorptive filters instead absorb light of certain wavelengths as is common general knowledge. Interference filters and absorptive filters are known per se.

In embodiments, the spatially separated additional filter areas may be arranged on opposite sides of a center of the photodetector pixel array. This advantageously provides for the light having passed through the spatially separated additional filter areas to be collected at larger angles than the light having passed through the first filter area. The image quality in areas of light collected at large angles is less suitable for imaging but sufficient for anti-spoofing.

On opposite sides of a center may be on opposite sides of an axis crossing through a center point of the photodetector pixel array, for example, the spatially separated additional filter areas do not share a common quadrant of the photodetector pixel array. In some possible embodiments, the spatially separated additional filter areas are symmetrically arranged with respect to a center of the photodetector pixel array.

In embodiments, the transmission wavelength bands of at least two spatially separated additional filter areas may be substantially equal. This provides for increased detection area and thereby for reduced noise of the total signal acquired by the corresponding set of pixels. Further, it may assist in cases where the finger does not cover the entire sensor area. In other words, the likelihood that the finger covers an area of the additional filter areas having a predetermined transmission spectrum is increased by having more than one such additional filter area.

In other embodiments, the transmission wavelength bands of at least two spatially separated additional filter areas may be different. Thus, the inventive concept provides for selecting different transmission spectrums of the additional filter areas to thereby choose two colors whose ratio is unique to skin color. This provides for improved anti-spoofing. Further, the transmission spectrums of the additional filter areas may be tailored to specific spoof materials such as e.g. white paper spoofs, red paper spoofs, wood glue spoofs, polymer spoofs, etc.

The filter areas may be of various sizes covering one or more pixels.

In one embodiment, each of the additional filter areas may be arranged to cover at least two pixels of the photodetector pixel array. In other words, the area of each of the additional filter areas corresponds to the area of at least two pixels. Advantageously, using larger areas provide for better anti-spoofing performance.

Preferably, the first filter area is arranged to cover at least two pixels of the photodetector pixel array. Preferably, the first filter area is arranged to cover enough pixels suitable for biometric imaging for biometric verification purposes.

Preferably, the additional filter areas may be arranged to cover areas of the photodetector pixel array corresponding to lower resolution portions in a captured image compared to the resolution in portions of the image corresponding to the area covered by the first filter area. In other words, the lower resolution areas are preferably utilized for anti-spoofing and the higher resolution areas are preferably used for biometric imaging.

In embodiments, the additional filter areas may be arranged to cover outer edge pixels of the photodetector pixel array.

In embodiments, the additional filter areas may be arranged to cover corner portions of the photodetector pixel array.

Edge pixels or corner portion pixels generally provide lower resolution image portions more suitable for anti-spoofing than for biometric verification.

The first filter area may be transmissible to light of wavelengths corresponding to blue light and green light. The first filter area may be adapted to suppress wavelengths corresponding to red light. This provides for images better adapted for biometric verification.

The additional filter areas may be transmissible to light of wavelengths corresponding to red light, green light, and blue light.

However, the first filter area and the additional filter areas are adapted to block or at least suppress infrared light so that infrared light at too high intensities do not reach the photodetector pixel array.

In other words, although the low-resolution areas of an acquired image, such as the corners of the image, may have little use in terms of biometric performance, these areas of the image may advantageously be exploited for anti-spoofing purposes as realized by the inventors. Anti-spoofing schemes may rely on spectral information in the light scattered from biometric objects such as fingers.

For example, the infrared cut-off filter according to embodiments of the invention may be situated in front of the image sensor so that the parts of the image with good resolution are formed by e.g. blue and green light, whereas a wider spectrum is transmitted in the low-resolution areas corresponding the additional filter areas. In that way, the low-resolution parts of the image around e.g. two of its corners may be used to determine whether the spectral information in the light reaching the sensor matches that of light scattered from a real biometric object such as a finger.

However, in other possible implementations, the transmission spectrums of the additional filter areas are narrower than the transmission spectrum of the first filter area. For example, the additional filter areas may be transmissive to only light in the red wavelengths range, or in two different wavelength ranges, i.e. a first additional filter area may be transmissive to light in a first additional wavelength band and a second additional filter area may be transmissive to light in a second additional wavelength band different from the first additional wavelength band. The first additional wavelength band and the second additional wavelength band being narrower than the first transmission wavelength band of the first filter area. For example, the first additional wavelength band may correspond to a wavelength band of a first one of red light, blue light, and green light, and the second additional wavelength band may correspond to a wavelength band of a second one of red light, blue light, and green light,

In some embodiments, the biometric imaging arrangement may be configured to perform anti-spoofing analysis by acquiring an image of a biometric object, such as a fingerprint image, and analyzing image content along an axis intercepting with the corresponding locations of the additional filter areas. In other words, anti-spoofing is advantageously used based on image content acquired by pixels arranged below the additional filter areas.

Further, the biometric imaging arrangement may preferably be configured to perform biometric verification by acquiring a fingerprint image and analyzing image content along an axis corresponding only to the first filter area. In other words, biometric verification is advantageously used based on image content acquired by pixels arranged below the first filter area, so that the pixels receive light having passed through the first filter area.

Preferably, the infrared cut-off filter may be arranged to cover the entire photodetector pixel array. This advantageously reduces the amount of stray light from reaching the image sensor photodetector pixel array.

In embodiments, the biometric imaging arrangement may be configured to be arranged under an at least partly transparent display panel and to acquire an image of an object located on the opposite side of the least partly transparent panel.

The transparent display panel may comprise the color controllable light source. Such as a display based on OLED, u-LED with any type of tri-stimulus emission like RGB, CMY or others.

In embodiments, the first filter area may be configured to at least partly suppress transmission of light in a first wavelength range, and at least two of the additional filter areas may be transmissible to light of wavelengths in the first wavelength range. In other words, the additional filter areas are adapted to pass a wavelength range that the first filter areas are adapted to block. For example, the first filter area may be adapted to at least partly suppress transmission of red light, and at least two of the additional filter areas may be transmissible to red light.

Alternatively, the additional filter areas are transmissive to a narrower wavelength band that the first filter area. For example, the first filter area may be transmissive to light in a wavelength band corresponding to blue and green and the additional filter areas may be transmissive to light in a wavelength band corresponding to only blue light. This could be used for performing anti-spoofing using a narrow wavelengths band.

According to a second aspect of the invention, there is provided an electronic device comprising: an at least partly transparent display panel; the biometric imaging arrangement according to any one herein disclosed embodiment, and processing circuitry configured to: receive a signal from the biometric imaging arrangement indicative of a biometric object touching the transparent display panel, perform a biometric authentication procedure based on the detected biometric object.

A biometric object may be a fingerprint.

The electronic device may be e.g. a mobile device such as a mobile phone (e.g. smartphone), a tablet, a phablet, smart watch, etc.

Further effects and features of the second aspect of the invention are largely analogous to those described above in connection with the first aspect of the invention.

According to a third aspect of the invention, there is provided a method for biometric authentication using a biometric imaging arrangement comprising an image sensor having a photodetector pixel array for capturing an image of an object, and an infrared cut-off filter arranged to at least partly cover the photodetector pixel array.

The method comprises acquiring an image of an object using the image sensor.

A first set of pixels of the image sensor is arranged to receive light transmitted through a first filter area of the infrared cut-off filter, the first filter area having a first transmission wavelength band including wavelengths in the visible range of wavelengths.

At least two further sets of pixels are arranged to receive light transmitted through a respective one of at least two additional filter areas of the infrared cut-off filter, the at least two additional filter areas having transmission wavelength bands including wavelengths in the visible range of wavelengths.

The transmission wavelength bands of the additional filter areas being different from the first transmission wavelength band, wherein the at least two further sets of pixels are spatially separated by the first set of pixels.

The method comprises performing biometric authentication processing based on the acquire image.

In embodiments, the method may comprise performing anti-spoofing analysis by analyzing image content along an axis intercepting with the corresponding locations of the further sets of pixels.

In embodiments, the method may comprise performing biometric verification by analyzing image content along an axis corresponding only to the first set of pixels.

Further effects and features of the third aspect of the invention are largely analogous to those described above in connection with the first aspect and the second aspect of the invention.

According to a fourth aspect of the invention, there is provided a method for manufacturing an infrared cut-off filter arrangeable to at least partly cover a photodetector pixel array.

The method comprising providing at least one layer of a first filter material on a first zone of a substrate, the at least one layer of the first filter material having a first transmission wavelength band including wavelengths in the visible range of wavelengths.

The method further comprising providing at least one layer of a second filter material on at least two additional zones of the substrate, the at least one layer of the second filter material having transmission wavelength bands including wavelengths in the visible range of wavelengths.

The transmission wavelength bands of the at least one layer of the second filter material is different from the first transmission wavelength band, wherein at least two of the additional zones are spatially separated by the first zone.

The substrate may be a transparent substrate such as a glass or polymer substrate.

In some embodiments, the substrate is the image sensor. In other words, the image sensor may be coated by the filter layers.

The filter layers may be provided as thin films.

In embodiments, the second filter material forms a color filter, and the first filter material forms an interference filter at least partly covering the color filter, wherein the cut-off wavelength of the color filter exceeds the cut-off wavelength of the interference filter.

Further effects and features of the fourth aspect of the invention are largely analogous to those described above in connection with the first aspect and the second aspect and the third aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 conceptually illustrates a side-view of a biometric imaging arrangement according to embodiments of the invention;

FIG. 2 conceptually illustrates a top view of an infrared cut-off filter for a biometric imaging arrangement according to embodiments of the invention;

FIG. 3 conceptually illustrates a top view of an infrared cut-off filter for a biometric imaging arrangement according to embodiments of the invention;

FIG. 4 conceptually illustrates a top view of an infrared cut-off filter for a biometric imaging arrangement according to embodiments of the invention;

FIG. 5 conceptually illustrates a top view of an infrared cut-off filter arranged on an image sensor according to embodiments of the invention;

FIG. 6A conceptually illustrates an example image of a real fingerprint;

FIG. 6B conceptually illustrates an example image of a fake fingerprint;

FIG. 7 conceptually illustrates a schematic side-view of a biometric imaging arrangement arranged under an at least partly transparent display according to embodiments of the invention;

FIG. 8 is a flow-chart of method steps according to embodiments of the invention;

FIG. 9 schematically illustrates an example of an electronic device according to embodiments of the invention;

FIG. 10 is a schematic box diagram of an electronic device according to embodiments of the invention;

FIG. 11 is a flow-chart of method steps according to embodiments of the invention;

FIG. 12A-C conceptually illustrate manufacturing steps according to embodiments of the invention;

FIG. 13A-C conceptually illustrates manufacturing steps according to embodiments of the invention;

FIG. 14A-C conceptually illustrates manufacturing steps according to embodiments of the invention;

FIG. 15 conceptually illustrates a top view of an infrared cut-off filter for a biometric imaging arrangement according to embodiments of the invention; and

FIG. 16 is a transmittance graph conceptually illustrating two different transmission wavelength bands.

### DETAILED DESCRIPTION OF EXAMPLE EMBODIMENTS

In the present detailed description, various embodiments of the biometric imaging arrangement according to the present invention are mainly described with reference to a biometric imaging arrangement arranged under a display panel for capturing a fingerprint image. However, it should be noted that the described imaging device also may be used in other optical fingerprint imaging applications such as in an optical fingerprint sensor located under a cover glass or the like.

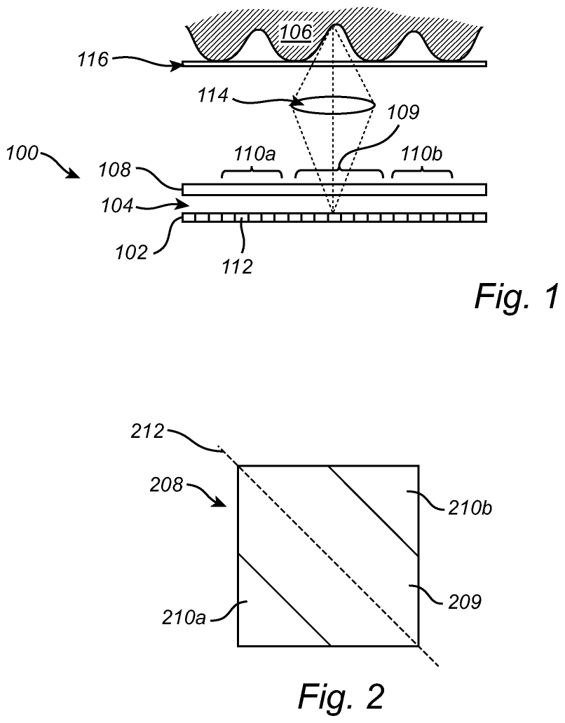

FIG. 1 is a conceptual side view of a biometric imaging arrangement 100 comprising an image sensor 102 comprising a photodetector pixel array 104 for capturing an image of an object 106. Further, an infrared cut-off filter 108 arranged to at least partly cover the photodetector pixel array 104.

The infrared cut-off filter 108 comprises a first filter area 109 having a first transmission wavelength band including wavelengths in the visible range of wavelengths.

The infrared cut-off filter 108 further comprises at least two additional filter areas 110a, 110b having transmission wavelength bands including wavelengths in the visible range of wavelengths. The transmission wavelength bands of the additional filter areas 110a, 110b, are different from the first transmission wavelength band. Further, the additional filter areas 110a-b are spatially separated from each other by the first filter area 109.

The photodetectors 112 are individually controllable and configured to detect an amount of incoming light and to generate an electric signal indicative of the light received by the photodetectors 112.

Light that is transmitted from the object 106, for example a finger, is filtered differently depending on which area of the filter 110 that the light passes through. However, the filter 108 provides infrared cut-off across the entire filter area.

The filter areas may be arranged in various ways, with the requirement that the at least two filter areas are spatially separated by the first filter area.

In FIG. 1, conceptual light beams transmitted from a finger 106 placed on a cover structure 116 are illustrated. The light beams are focused by a lens assembly 114 onto the image sensor 102 after having passed through the infrared cut-off filter 108.

Turning now to FIG. 2 illustrating a conceptual top view of an infrared cut-off filter 208 according to embodiments of the present invention. The infrared cut-off filter 208 comprises a first filter area 209 having a first transmission wavelength band including wavelengths in the visible range of wavelengths. Further, the infrared cut-off filter 208 comprises two additional filter areas 210a and 210b spatially separated from each other by the first filter area 209. In this embodiment, the additional filter areas 210a-b are arranged to cover corner portions of the photodetector pixel array. Thus, the additional filter areas 210a-b correspond to corners of the photodetector pixel array.

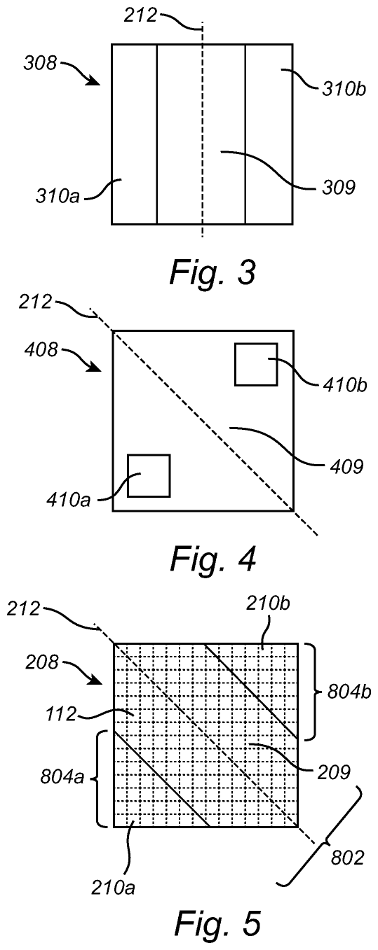

FIG. 3 is a top of another conceptual infrared cut-off filter 308 according to embodiments of the present invention. The infrared cut-off filter 308 comprises a first filter area 309 having a first transmission wavelength band including wavelengths in the visible range of wavelengths. Further, the infrared cut-off filter 308 comprises two additional filter areas 310a and 310b spatially separated from each other by the first filter area 310. In this embodiment, the additional filter areas 310a-b are arranged to cover outer edge pixels of the photodetector pixel array. Note that the additional filter areas 310a-b covers also corner portions of the photodetector pixel array but in a different way compared to the additional filter areas 210a-b in FIG. 2.

The additional filter areas 310a-b reach across the entire side of the filter 308.

FIG. 4 is a top of another conceptual infrared cut-off filter 408 according to embodiments of the present invention. The infrared cut-off filter 408 comprises a first filter area 409 having a first transmission wavelength band including wavelengths in the visible range of wavelengths. Further, the infrared cut-off filter 408 comprises two additional filter areas 410a and 410b spatially separated from each other by the first filter area 410.

The two additional filter areas 410a and 410b are arranged as islands in the first filter area 409. In other words, each of the additional filter areas 410a and 410b are surrounded by the first filter area 409, but still spatially separated from each other.

In each of filters illustrates in FIG. 2-4, are the spatially separated additional filter areas arranged on opposite sides of a center of the photodetector pixel array, when the filter is arranged on the image sensor. The line 212 denotes a hypothetical line through the center of the photodetector pixel array.

The transmission wavelength bands of at least two spatially separated additional filter areas, e.g. 210a and 210b, or 310a and 310b, or 410a and 410b may be substantially equal. However, it is also conceivable that the transmission wavelength bands of at least two spatially separated additional filter areas are different from each other.

FIG. 5 illustrates the filter 208 arranged on a photodetector pixel array where the pixels 112 are shown dashed to indicated that they are located under the filter 208. Again, the at least two spatially separated additional filter areas 210a and 210b are arranged in corners of the pixel array, however, as discussed, above other arrangement are also conceivable and within the scope of the invention.

The first filter area 209 covers a plurality of pixels, i.e. at least two pixels. Similarly, each of the additional filter areas 210a-b is arranged to cover a plurality of pixels, being at least two pixels 112, of the photodetector pixel array.

FIG. 16 schematically illustrates example transmission wavelengths bands for a first filter area, solid line 1602, and for at least one of the additional filter areas, dashed line 1604. The graphs illustrate one of several possible combinations of different transmission wavelength bands and serves as an example for embodiments herein.

In this example, the transmission wavelength band represented by the solid line 1602 has a cut-off wavelength at w2 which is at a lower wavelength than the cut-off wavelength w3 for the filter in the additional filter area. The wavelength band from cut-off wavelength w1 to cut-off wavelength w3 may represent the visible range of wavelengths. Note that the transmission wavelength bands are partly overlapping but at least one cut-off wavelength is different from both cut-off wavelengths of the other transmission band, here the upper cut-off wavelengths w2 and w3 are different from each other.

In some implementations, the transmission wavelength bands of the additional filter areas are narrower than the transmission wavelength band of the first filter area. Thus, now turning to FIG. 16 again, the transmission wavelengths band corresponding to the solid line 1602 may be that of an additional wavelength area, and the dashed line 1604 may be the transmission wavelength band of the first filter area. For example, the additional filter areas 210a-b may each be transmissible to light of wavelengths corresponding to only one of red light, green light, and blue light, whereas the first filter area is transmissible to a broader range of wavelengths, such as the entire visible range of wavelengths, or at least to light of wavelengths corresponding to red light, green light, and blue light.

In embodiments, the first filter area 209 is transmissible to light of wavelengths corresponding to blue light and green light. The first filter area 209 may also be adapted to suppress wavelengths corresponding to red light. For example, in the transmission band represented by line 1602 the cut-off wavelength w2 may provide for suppressing red light. Red light may for example be in the range of wavelengths between w2 and w3.

The additional filter areas 210a-b may be transmissible to light of wavelengths corresponding to red light, green light, and blue light. In the example shown in FIG. 16, the cut-off wavelength w3 may thus provide for allowing transmission of red light that is suppressed by the first filter area, represented by the solid line 1602 with cut-off wavelength w2, in FIG. 16. In other words, in some embodiments, the first filter area 210 is configured to at least partly suppress transmission of light in a first wavelength range, here corresponding to red light. The at least two additional filter 210a-b may be transmissible to light of wavelengths in the first wavelength range, here corresponding to red light.

Thus the infrared cut-off filter 208, or any of the filters according to embodiments of the invention, may be situated in front of the image sensor 102 so that the parts of the image with good resolution are formed by e.g. blue and green light, whereas a wider spectrum is transmitted in the low-resolution areas corresponding the additional filter areas 210a-b. In that way, the low-resolution parts of the image around e.g. two of its corners may be used to determine whether the spectral information in the light reaching the sensor matches that of light scattered from a real biometric object such as a finger.

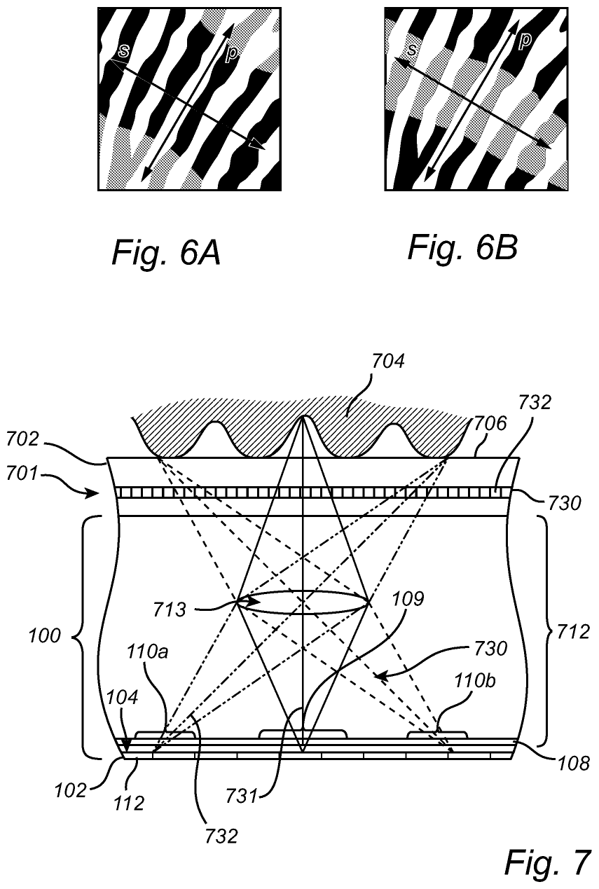

For example, and now turning to FIGS. 6A-B, each conceptually illustrating an image captured by an under-display fingerprint sensor.

During imaging, the object is illuminated with display light polarized +45 or −45 degrees with respect to the vertical direction of the display. When light is collected at very large angles, such as larger than about 20 degrees or larger than about 30 degrees, the polarized light will affect the captured image properties, especially along the two diagonals. Here, this is referred to ‘s’ and ‘p’ polarization.

FIG. 6A conceptually illustrates an image of a fingerprint of a live object, and FIG. 6B conceptually illustrates an image of a fake fingerprint.

In FIG. 6A showing the real fingerprint image, the contrast is better along the upper-left to lower-right diagonal compared to along the other diagonal, whereas, the image contrast in FIG. 6B is better along the opposite diagonal, i.e. along the lower-left to upper-right diagonal. When differentiating between real fingerprints and spoofs, it is advantageous to include red light, which is often suppressed in biometric verification. Thus, the herein proposed infrared cut off filter may be arranged with the additional filter areas in corresponding low resolution areas of an image, here along the upper-right to lower-left diagonal, for example in the corners, and the additional filer areas may allow transmission of red light. The filter area corresponding to high resolution areas, here along the upper-left to lower-right diagonal, may supress red light and transmit blue and green light.

In the normal biometric verification, the image content along the ‘s’ diagonal, where red light is suppressed, is used. And for spoof detection, the image content along the ID′ diagonal, where red light is transmitted, is used.

Accordingly, the biometric imaging arrangement may be configured to perform anti-spoofing analysis by acquiring a fingerprint image and analyzing image content along an axis intercepting with the corresponding locations of the additional filter areas.

Further, the biometric imaging arrangement may be configured to perform biometric verification by acquiring a fingerprint image and analyzing image content along an axis corresponding only to the first filter area.

The infrared cut-off filter 208 is preferably arranged to cover the entire photodetector pixel array. This provides for protecting the image sensor pixels from infrared radiation which otherwise may saturate the image sensor.

FIG. 7 schematically illustrates a biometric imaging arrangement 100 according to an embodiment of the invention. The biometric imaging arrangement 100 is here arranged under an at least partially transparent display panel 701. However, the biometric imaging arrangement 100 may be arranged under any cover structure which is sufficiently transparent, as long as the image sensor 102 receives a sufficient amount of light to capture an image of a biometric object in contact with the outer surface of the cover structure, such as a fingerprint or a palmprint. In the following, a biometric imaging arrangement 100 configured to capture an image of a finger 704 in contact with an outer surface 706 of a cover glass 702 of the display panel 701 is described.

The biometric imaging arrangement 100 comprises the image sensor 102 including the photodetector pixel array 104, where each pixel 112 is an individually controllable photodetector configured to detect an amount of incoming light and to generate an electric signal indicative of the light received by the detector.

In some embodiments, the biometric imaging arrangement 100 further comprises an optical stack 712 arranged to cover the image sensor 102. The optical stack 712 may include various layers and components such as a transparent substrate covering the image sensor 102, a set of optical redirection elements such as lenses 713, opaque layers having of separate openings for the lenses, an adhesive layer to attach the display panel 701 to the biometric imaging sensor 100, air gaps, and antireflection coatings.

### Biometric Imaging Arrangement

Moreover, for completeness, the at least partly transparent display panel 701 here comprises a color controllable light source 730 comprising individually controllable light emitting pixels 732. For acquiring an image of e.g. a fingerprint or palmprint, the color controllable light source 730 may emit light that is reflected by the finger 704 and detected by the pixels 112 of the image sensor 102. There are suitable openings or optical paths past the color controllable light source 730 so that the light beams being transmitted from the finger 704 can reach the image sensor 102.

The optical filter assembly 108 is arranged in the optical stack 712 and is here shown arranged on the image sensor 102 below the lens 713. However, the optical filter assembly 108 may equally well be arranged elsewhere in the optical stack 712 such as between a lens 713 and the display 701. In such case, a structure in the optical stack 712 may serve as a support structure for the infrared cut-off filter 108.

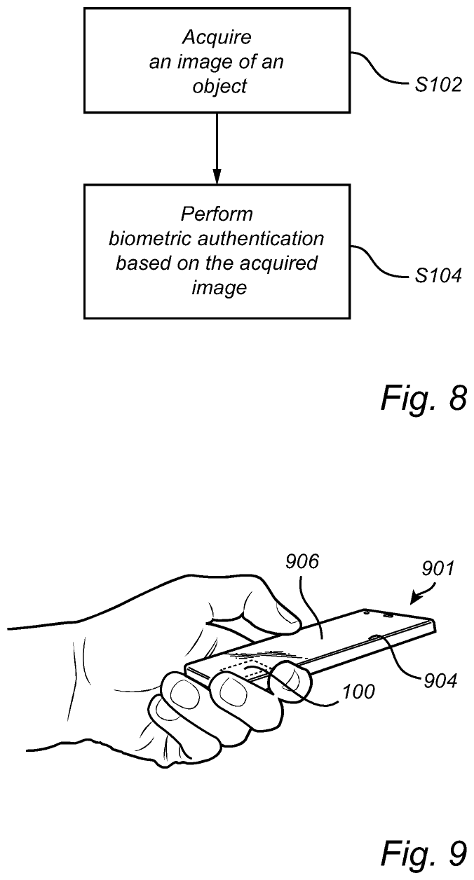

FIG. 8 is a flow-chart of method steps according to embodiments of the invention. The flow-chart in FIG. 8 will be described in conjunction with FIG. 1, FIG. 2, and FIG. 5. The method concerning biometric authentication using a biometric imaging arrangement 100 comprising an image sensor 102 having a photodetector pixel array 104 for capturing an image of an object 106, and an infrared cut-off filter 208 arranged to at least partly cover the photodetector pixel array.

The method comprises a step S104 of acquiring an image of an object using the image sensor.

A first set 802 of pixels of the image sensor (see FIG. 5) is arranged to receive light transmitted through a first filter area 209 of the infrared cut-off filter 208. The first filter area 209 having a first transmission wavelength band including wavelengths in the visible range of wavelengths.

The image sensor 102 comprises at least two further sets 804a-b of pixels arranged to receive light transmitted through a respective one of at least two additional filter areas 210a-b of the infrared cut-off filter 208. The at least two additional filter areas 210a-b having transmission wavelength bands including wavelengths in the visible range of wavelengths. The transmission wavelength bands of the additional filter areas being different from the first transmission wavelength band, wherein the at least two further sets of pixels are spatially separated by the first set of pixels.

In step S104, performing biometric authentication processing based on the acquired image.

The step S104 of performing biometric authentication may comprise performing anti-spoofing analysis by analyzing image content along an axis intercepting with the corresponding locations of the further sets 804a-b of pixels. In other words, anti-spoofing may be performed using image content along the axis intercepting with image portions corresponding to the additional filter areas 210a-b.

The step S104 of performing biometric authentication may comprise performing biometric verification by analyzing image content along an axis corresponding only to the first set of pixels. In other words, biometric verification may be performed using image content along the axis corresponding only to the first filter area 209.

The above description of the method refers to FIGS. 2 and 5 to exemplify pixels and filter areas. However, any one of the other filters, e.g. such as shown in FIGS. 3-4 may equally well have served as example embodiments for the method of FIG. 8.

Performing biometric verification is per se considered known to the skilled person and will not be described in detail herein.

Turning now to FIG. 9, there is a schematically illustrated example of an electronic device configured to apply the concept according to the present disclosure, in the form of a mobile device 901 with an integrated in-display biometric imaging device 100 and a display panel 904 with a touch screen interface 906. The biometric imaging device 100 may, for example, be used for unlocking the mobile device 901 and/or for authorizing transactions carried out using the mobile device 901, etc. Furthermore, the biometric imaging device 100 may further be used for gesture recognition performed by a user for controlling action on the electronic device.

Preferably and as is apparent for the skilled person, the mobile device 901 shown in FIG. 9 further comprises a first antenna for WLAN/Wi-Fi communication, a second antenna for telecommunication communication, a microphone, a speaker, and a phone control unit. Further hardware elements are of course possibly comprised with the mobile device.

It should furthermore be noted that the invention may be applicable in relation to any other type of electronic devices comprising at least partly transparent display panels, such as a laptop, a tablet computer, etc.

The biometric imaging arrangement 100 is here shown to be relatively small, a so-called hot-zone implementation. Embodiments shown herein are possible to implement in in-display imaging devices.

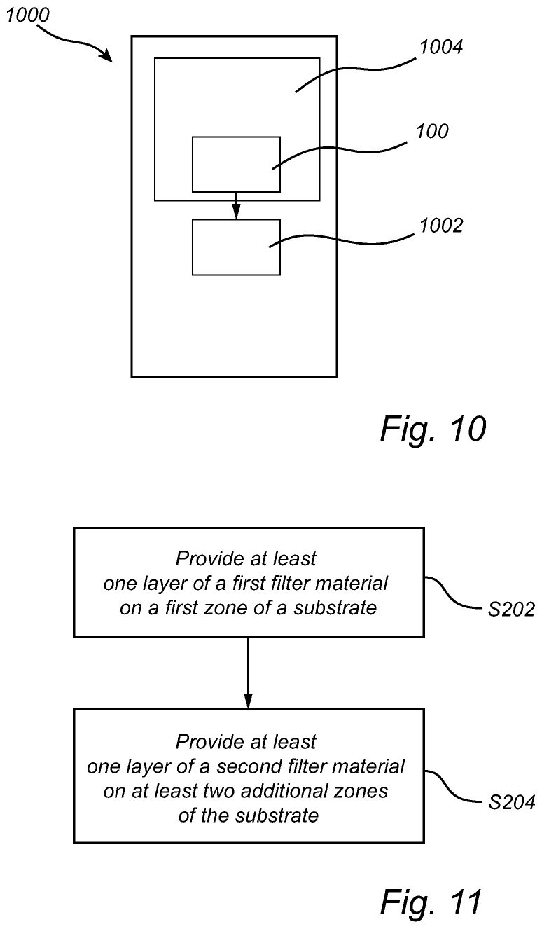

FIG. 10 is a schematic box diagram of an electronic device according to embodiments of the invention. The electronic device 1000 comprises a transparent display panel 1004 and a biometric imaging arrangement 100 conceptually illustrated to be arranged under the transparent display panel 1004 according to embodiments of the invention. Furthermore, the electronic device 1000 comprises processing circuitry such as control unit 1002. The control unit 1002 may be stand-alone control unit of the electronic device 1000, e.g. a device controller. Alternatively, the control unit 1002 may be comprised in the biometric imaging arrangement 100.

The control unit 1002 is configured to receive a signal indicative of a detected object from the biometric imaging arrangement 100. The received signal may comprise image data.

The control unit 1002 is configured to detect a fingerprint based on the received signal. Further, the control unit 1002 is configured to perform a fingerprint authentication procedure for identifying the user based on the detected fingerprint. Such fingerprint authentication procedures, or biometric verifications, are considered per se known to the skilled person and will not be described in further detail herein.

Further, the control unit 1002 is configured to, based on the obtained image of the object, to perform anti-spoofing analysis by analyzing image content along an axis intercepting with the corresponding locations of the further sets of pixels 804a-b.

Further, the control unit 1002 is configured to, based on the obtained image of the object, perform biometric verification by analyzing image content along an axis corresponding only to the first set 802 of pixels.

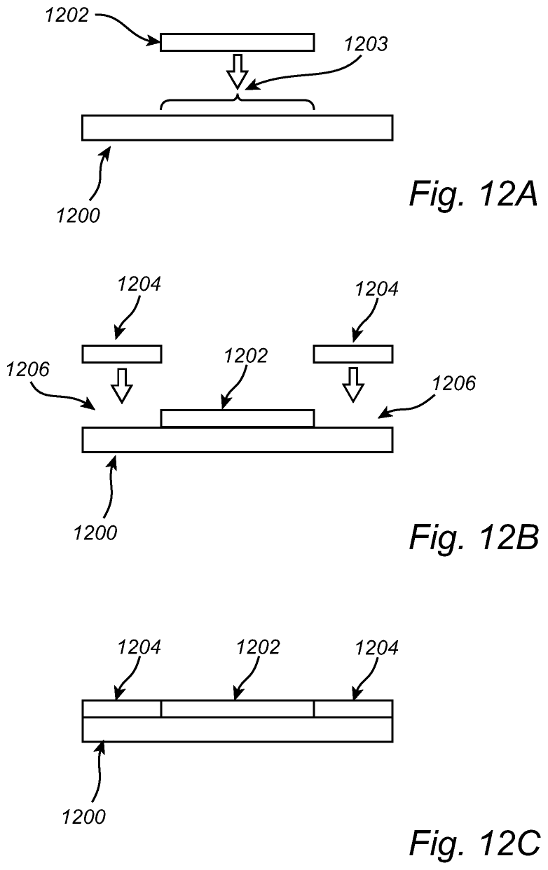

FIG. 11 is a flow-chart of method steps according to embodiments of the invention. The method is for manufacturing an infrared cut-off filter arrangeable to at least partly cover a photodetector pixel array and will be described in conjunction with FIGS. 12A-C.

The method comprising step S202 of providing at least one layer of a first filter material on a first zone of a substrate. The at least one layer of the first filter material having a first transmission wavelength band including wavelengths in the visible range of wavelengths.

Turning to FIG. 12A, a layer of a first filter material 1202 is provided on the substrate 1200, in the first zone 1203. This may be performed by depositing the filter material through a suitable resist layer or mask using thin film lithography methods to form a thin film comprising the first filter material 1202 on the substrate 1200.

In step S204 the method comprises providing at least one layer of a second filter material on at least two additional zones of the substrate. The at least one layer of the second filter material has a transmission wavelength band including wavelengths in the visible range of wavelengths. Further, the transmission wavelength bands of the at least one layer of the second filter material is different from the first transmission wavelength band.

Turning to FIG. 12B, the layer of a second filter material 1204 is provided on the substrate 1200, in the second zones 1206. This may be performed by depositing the filter material through a suitable resist layer or mask using thin film lithography methods to form a thin film comprising the first filter material 1204 on the substrate 1200, in the zones 1206.

At least two of the additional zones 1206 are spatially separated by the first zone 1203.

FIG. 12C illustrates the substrate 1200 having the second filter material 1204 zones separated by the first filter layer zone 1202.

In embodiments, the substrate 1200 is a transparent substrate such as a glass substrate.

In other embodiments, the substrate 1200 is the image sensor. Thus, the filter layers are formed directly on the photodetector pixel array of the image sensor.

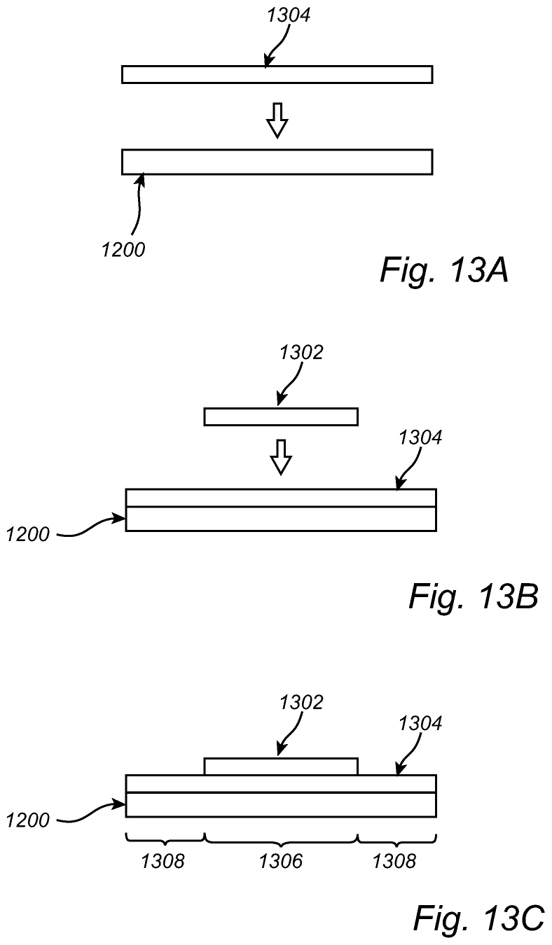

In some embodiments, the second filter material is provided on the substrate before the first filter material. Turning to FIGS. 13A, firstly, the second filter material 1304 is provided on the substrate 1200. Secondly, now turning to FIG. 13B, the first filter material 1302 is provided on the substrate 1200, and least partly on the second filter material 1304.

FIG. 13C illustrates the substrate 1200 having the first filtering material 1302 covering a first zone 1306 that separates the second zones 1308 covered by the second filter material 1304. The first filter material 1302 at least partly covering the second filter material 1304.

The second filter material 1304 may for example form a color filter, and the first filter material 1302 may form an interference filter at least partly covering the color filter. In such implementation, the cut-off wavelength of the color filter exceeds the cut-off wavelength of the interference filter. For example, the cut-off wavelength of the color filter may allow red light to be transmitted whereas the cut-off wavelength of the first filter material 1302 may at least partly or entirely block red light.

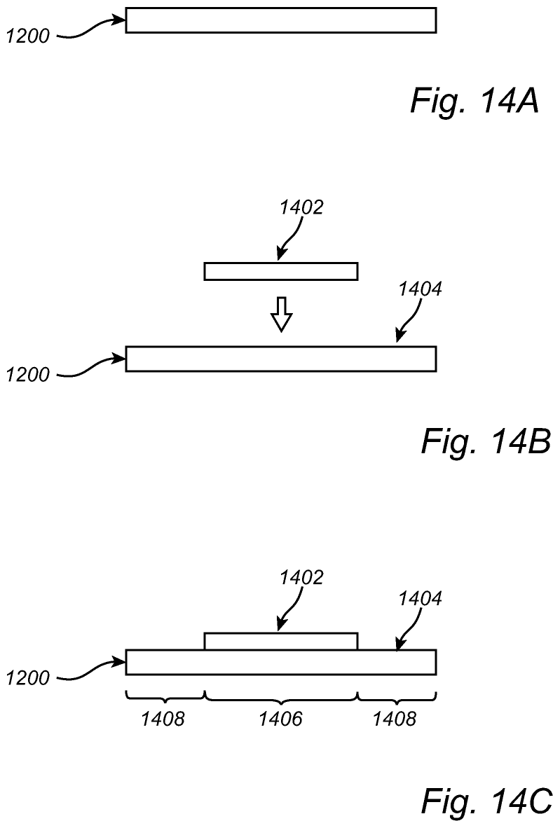

In some embodiment, the substrate 1200 is an absorptive color filter onto which the first filter material is deposited onto. Turning to FIGS. 14A-C, in FIG. 14A, providing a substrate 1200 comprising a second filter material 1404, i.e. the substrate is itself a second type of filter. Next, in FIG. 14B, the first filter material 1402 is deposited onto the substrate 1200.

FIG. 14C illustrates the substrate 1200 having the first filtering material 1302 covering a first zone 1406 that separates the second zones 1408 comprising the second filter 1404. The substrate 1200 may be a tinted glass substrate. The first filter material 1402 may equally well be manufactured, or attached to, a bottom side of the substrate 1200 such that the first filter material 1402 faces towards the photodetector array when installed on the image sensor. The absorptive filter 1200 may thus serve as a substrate for the first filter material 1402, which may form an interference filter. For example, the absorptive filter may be a tinted glass substrate on which an interference filter is manufactured in a layered structure of antireflection coatings and/or other interference filter components.

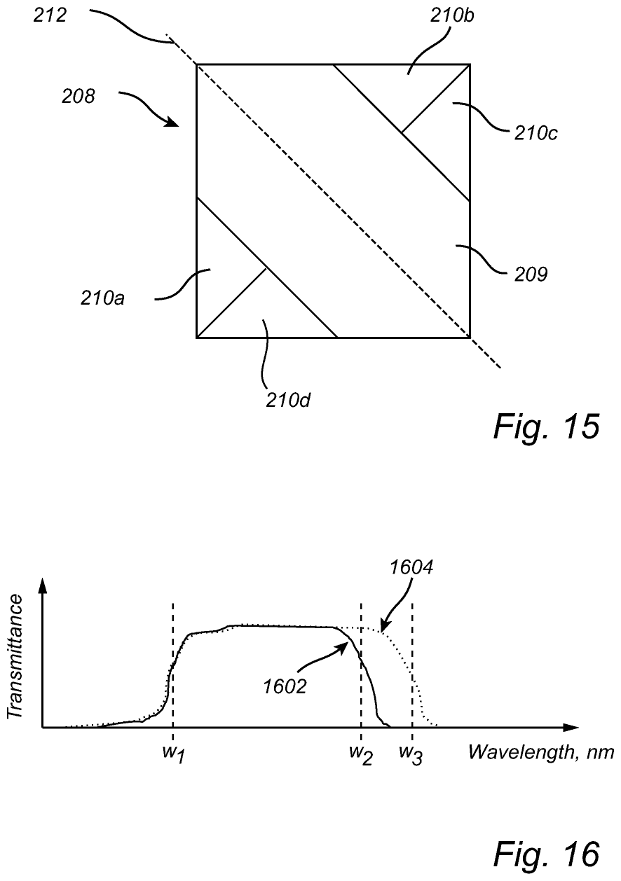

FIG. 15 conceptually illustrates the infrared cut-off filter 208 but now with further additional filter areas 210c and 210d. Thus, in addition to the previously described additional filter areas 210a and 210b, there filter 208 comprises additional filter areas 210c and 210d that are separated from each other but adjacent to respective additional filter areas 210b and 210a. The adjacent additional filter areas 210a and 210d may have wavelength transmission band that are different from each other, and the adjacent additional filter areas 210b and 210c may have wavelength transmission bands that are different from each other. This type of configuration allows for further possibilities for spectral analysis for anti-spoofing and thus improved anti-spoofing capabilities.

A control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device. It should be understood that all or some parts of the functionality provided by means of the control unit (or generally discussed as “processing circuitry”) may be at least partly integrated with the biometric imaging arrangement.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Even though the invention has been described with reference to specific exemplifying embodiments thereof, many different alterations, modifications and the like will become apparent for those skilled in the art. Also, it should be noted that parts of the imaging device and method for manufacturing the imaging device may be omitted, interchanged or arranged in various ways, the imaging device yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A biometric imaging arrangement comprising:
an image sensor comprising a photodetector pixel array for capturing an image of an object;
an infrared cut-off filter arranged to at least partly cover the photodetector pixel array, wherein the infrared cut-off filter comprises:
a first filter area having a first transmission wavelength band including wavelengths in the visible range of wavelengths, the first filter area being arranged to transmit filtered light to a first set of pixels, and
at least two additional filter areas having transmission wavelength bands including wavelengths in the visible range of wavelengths, the transmission wavelength bands of the additional filter areas being different from the first transmission wavelength band, the at least two additional filter areas being arranged to transmit filtered light for anti-spoofing to at least two further sets of pixels, spatially separated by the first set of pixels, wherein at least two of the additional filter areas are spatially separated by the first filter area so that light received by the first set of pixels is filtered differently compared to light received by the further sets of pixels.

2. The biometric imaging arrangement according to claim 1, wherein the spatially separated additional filter areas are arranged on opposite sides of a center of the photodetector pixel array.

3. The biometric imaging arrangement according to claim 1, wherein the transmission wavelength bands of at least two spatially separated additional filter areas are substantially equal.

4. The biometric imaging arrangement according to claim 1, wherein the transmission wavelength bands of at least two spatially separated additional filter areas are different.

5. The biometric imaging arrangement according to claim 1, wherein each of the additional filter areas is arranged to cover at least two pixels of the photodetector pixel array.

6. The biometric imaging arrangement according to claim 1, wherein the first filter area is arranged to cover at least two pixels of the photodetector pixel array.

7. The biometric imaging arrangement according to claim 1, wherein the additional filter areas are arranged to cover areas of the photodetector pixel array corresponding to lower resolution portions in a captured image compared to the resolution in portions of the image corresponding to the area covered by the first filter area.

8. The biometric imaging arrangement according to claim 1, wherein the additional filter areas are arranged to cover outer edge pixels of the photodetector pixel array.

9. The biometric imaging arrangement according to claim 1, wherein the additional filter areas are arranged to cover corner portions of the photodetector pixel array.

10. The biometric imaging arrangement according to claim 1, wherein the first filter area is transmissible to light of wavelengths corresponding to blue light and green light.

11. The biometric imaging arrangement according to claim 1, wherein the first filter area is adapted to suppress wavelengths corresponding to red light.

12. The biometric imaging arrangement according to claim 1, wherein the additional filter areas are transmissible to light of wavelengths corresponding to red light, green light, and blue light.

13. The biometric imaging arrangement according to claim 1, configured to perform anti-spoofing analysis by acquiring an image of a biometric object and analyzing image content along an axis intercepting with the corresponding locations of the additional filter areas.

14. The biometric imaging arrangement according to claim 1, configured to perform biometric verification by acquiring an image of a biometric object and analyzing image content along an axis corresponding only to the first filter area.

15. The biometric imaging arrangement according to claim 1, wherein the infrared cut-off filter is arranged to cover the entire photodetector pixel array.

16. The biometric imaging arrangement according to claim 1, configured to be arranged under an at least partly transparent display panel of an electronic device.

17. The biometric imaging arrangement according to claim 1, wherein the first filter area is configured to at least partly suppress transmission of light in a first wavelength range, and
at least two of the additional filter areas being transmissible to light of wavelengths in the first wavelength range.

18. An electronic device comprising:
an at least partly transparent display panel;
the biometric imaging arrangement according to claim 1, and
processing circuitry configured to:
receive a signal from the biometric imaging arrangement indicative of a biometric object touching the transparent display panel,
perform a biometric authentication procedure based on the detected biometric object.

19. (canceled)

20. A method for biometric authentication using a biometric imaging arrangement comprising an image sensor having a photodetector pixel array for capturing an image of an object, and an infrared cut-off filter arranged to at least partly cover the photodetector pixel array, wherein the method comprises:
acquiring an image of an object using the image sensor,
wherein a first set of pixels of the image sensor is arranged to receive light transmitted through a first filter area of the infrared cut-off filter, the first filter area having a first transmission wavelength band including wavelengths in the visible range of wavelengths, and
at least two further sets of pixels arranged to receive light transmitted through a respective one of at least two additional filter areas of the infrared cut-off filter for anti-spoofing, the at least two additional filter areas having transmission wavelength bands including wavelengths in the visible range of wavelengths, the transmission wavelength bands of the additional filter areas being different from the first transmission wavelength band, wherein the at least two further sets of pixels are spatially separated by the first set of pixels so that light received by the first set of pixels is filtered differently compared to light received by the further sets of pixels, and
performing biometric authentication processing based on the acquired image.

21.-22. (canceled)

23. A method for manufacturing an infrared cut-off filter arrangeable to at least partly cover a photodetector pixel array, the method comprising:
providing at least one layer of a first filter material on a first zone of a substrate, the at least one layer of the first filter material having a first transmission wavelength band including wavelengths in the visible range of wavelengths;
providing at least one layer of a second filter material on at least two additional zones of the substrate, the at least one layer of the second filter material having transmission wavelength bands for use in anti-spoofing including wavelengths in the visible range of wavelengths, the transmission wavelength bands of the at least one layer of the second filter material being different from the first transmission wavelength band,
wherein at least two of the additional zones are spatially separated by the first zone so that the at least two of the additional zones are two distinct areas not directly adjacent to each other.

24.-26. (canceled)
